(19) United States
(12) Patent Application Publication
(10) Pub. No.: US 2026/0184133 A1
(43) Pub. Date: Jul. 2, 2026

(54) Sway Bar Adjuster Block

(71) Applicant: Rajan Thiru, Markham (CA)

(72) Inventor: Rajan Thiru, Markham (CA)

(73) Assignee: R Theory Motorsports LTD., Markham (CA)

(21) Appl. No.: 19/433,818

(22) Filed: Dec. 28, 2025

Related U.S. Application Data
(60) Provisional application No. 63/739,460, filed on Dec. 27, 2024.

(51) Int. Cl. B60G 21/055

(52) U.S. Cl. CPC B60G 21/0558; B60G 2202/135; B60G 2206/1112

(57) ABSTRACT

A sway bar adjuster assembly for an automotive suspension system includes an adjuster body and a backing plate configured to clamp to a terminal end-section of a sway bar. A primary fastener is disposed through the assembly and a pre-existing aperture in the sway bar to provide a compressive clamping force. At least one secondary fastener is threadably engaged with the adjuster body and is positioned substantially tangential to a perimeter margin of the sway bar to define a mechanical interference stop against rotational displacement. The adjuster body includes a plurality of mounting apertures at varying radial offsets to provide selectable mounting positions for a suspension end-link to modify roll stiffness. A reinforcement plate may be integrated via a multi-point load path to redistribute bending loads into the sway bar. Engagement surfaces may include integrally formed surface texturing for affirmative mechanical engagement.

### CROSS-REFERENCE TO RELATED APPLICATIONS

This application claims the benefit of U.S. Provisional Application No. 63/739,460, filed Dec. 27, 2024.

### BRIEF SUMMARY OF THE INVENTION

A universal retrofit adjustment assembly for automotive sway bars is disclosed. The assembly is configured to securely interface with the end-section of a sway bar to provide one or more selectable end-link mounting locations, thereby allowing for the selective stiffening or softening of the suspension's roll resistance without requiring component replacement. The assembly comprises an adjuster body and a backing plate secured via a primary fastener and a plurality of secondary fasteners. The secondary fasteners pass through the backing plate and thread into the adjuster body at a position tangential to the sway bar to provide a redundant mechanical stop against rotational displacement. Integrally formed friction-enhancing surface features provides additional resistance against rotational displacement. An optional reinforcement plate provides additional structural stability under dynamic lateral and torsional loads.

### FIELD OF THE INVENTION

The present invention relates to automotive suspension tuning and, more particularly, to a clamp-on assembly configured to selectively alter the effective anti-roll stiffness of an existing sway bar by modifying the effective lever arm length of said bar.

### BACKGROUND OF THE INVENTION

Anti-roll bars, also referred to as sway bars, are torsional spring elements used in vehicle suspension systems to mitigate body roll by transferring lateral load. The effective anti-roll stiffness is governed by the bar's material properties and the effective lever-arm length—defined as the distance between the torsional axis of the bar and the suspension end-link attachment point.

To adjust roll stiffness, users have historically been forced to choose between the total replacement of the factory bar with an aftermarket unit or the execution of permanent, destructive modifications to the original equipment (OE) bar, such as drilling or welding. Destructive modifications are undesirable as they introduce stress risers and compromise the metallurgical integrity and heat-treatment of the spring steel, which can lead to catastrophic component failure under dynamic loading.

While the concept of a non-destructive, adjustable interface is highly desirable, it has remained an unfulfilled need in high-load suspension applications. The technical barrier to such a device is the extreme torsional force acting upon the lever arm, which creates a tendency for any non-permanent attachment to rotate or “clock” around the bar. In the absence of a secondary mechanical limit, a friction-based attachment inevitably fails to maintain positional registration under competitive driving conditions. Accordingly, there exists a need for a high-strength, clamping adjuster assembly that provides selectable mounting geometry while ensuring absolute rotational stability through structural interference.

### SUMMARY OF THE INVENTION

The present invention provides a novel sway bar adjuster assembly that utilizes a dual-retention geometry to achieve mechanical stability. A primary fastener provides axial clamping force through an existing aperture in the bar, while at least one anti-rotation member—positioned offset from the primary fastener—serves as a physical interference stop against the bar's perimeter margin.

This configuration ensures that torsional forces are resisted by a mechanical “dead-stop” rather than relying solely on surface friction. By providing a plurality of selectable mounting apertures at varying radial distances from the sway bar axis, the assembly enables a user to selectively increase or decrease the effective anti-roll stiffness of the suspension by modifying the effective lever-arm length.

In certain embodiments, the assembly further comprises a reinforcement plate configured to redistribute bending loads away from the adjuster assembly and into the sway bar. This arrangement utilizes the inherent elasticity and fatigue resistance of the sway bar's spring-steel composition to absorb dynamic bending moments. By shifting these loads away from the fastener interface and into the flexible host material of the bar, the reinforcement plate protects the adjuster assembly from localized stress concentrations and unwanted deformation during extreme suspension articulation.

In further embodiments, one or more engagement surfaces of the assembly include integrally formed surface texturing. This texturing is configured to provide a high-friction interface or to minimally bite into the surface of the sway bar, ensuring an affirmative mechanical engagement that provides redundant rotational resistance supplemental to the mechanical limit provided by the anti-rotation member.

### BRIEF DESCRIPTION OF THE DRAWINGS

FIG. 1 is a front perspective view of the sway bar adjuster assembly shown in an installed state.

FIG. 2 is a side elevation view of the assembly.

FIG. 3 is an exploded front perspective view of the assembly.

FIG. 4 is an exploded rear perspective view of the assembly.

FIG. 5 is a detail view of a friction-enhancing engagement surface.

FIG. 6 is a detail view illustrating a mechanical stop relationship between the secondary fasteners and the sway bar.

### DETAILED DESCRIPTION OF THE PREFERRED EMBODIMENTS

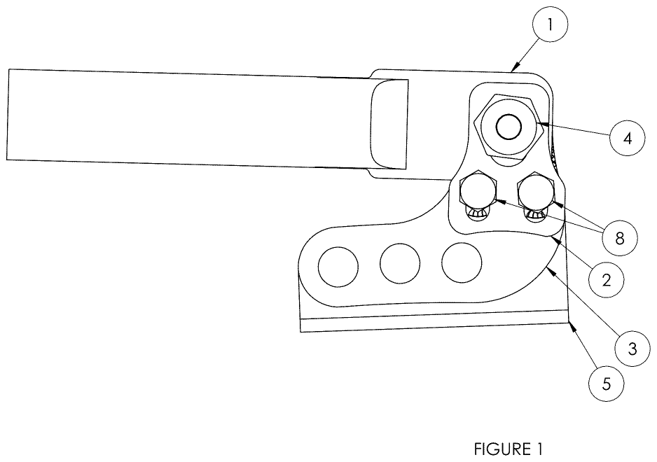

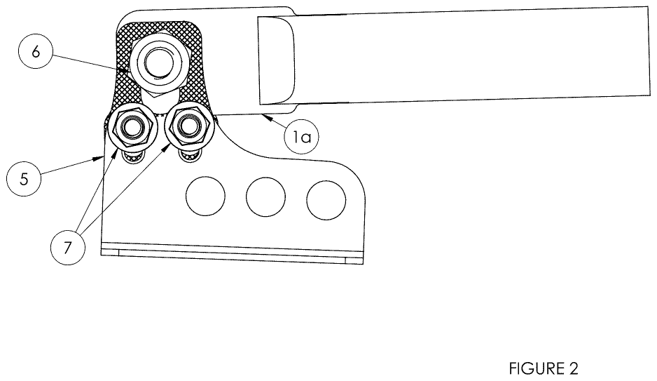

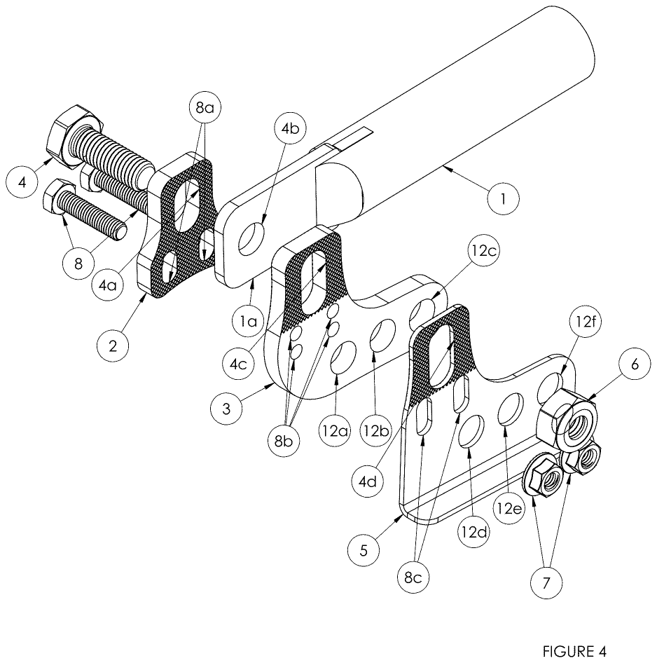

Referring to FIGS. 1-4, the assembly is designed to mount to the terminal end-section of a sway bar (1). While the assembly is frequently used to provide adjustability to non-adjustable bars, it is equally compatible with factory-adjustable bars to provide additional stiffness settings or to remediate a bar with compromised factory mounting apertures.

### The Adjuster Body and Mounting Geometry

The adjuster body (3) serves as the primary mounting interface. It includes a plurality of mounting apertures (12a, 12b, 12c), positioned at varying radial offsets from the torsional axis of the sway bar (1). These apertures define a selectable mounting array. By selectively shifting a suspension end-link to an aperture (e.g., 12a) closer to the sway bar axis, the user reduces the effective lever-arm length, thereby increasing the bar's rate of resistance to body roll.

### Primary and Secondary Fastening System

The assembly is secured via a multi-layered compressive clamping force. A backing plate (2) is disposed on the opposing side of the sway bar (1). A primary fastener (4) is disposed through a series of aligned apertures comprising a backing plate aperture (4a), a sway bar aperture (4b), and an adjuster body aperture (4c). In embodiments utilizing a reinforcement plate (5), the primary fastener (4) further extends through a reinforcement plate aperture (4d). The assembly is secured by a nut (6) to provide a primary friction joint.

To provide redundant security against high-vibration environments and rotational loads, one or more secondary fasteners (8) are utilized. These fasteners (8) pass through corresponding elongated clearance apertures (8a) in the backing plate (2) and thread directly into matching threaded bores (8b) disposed within the adjuster body (3).

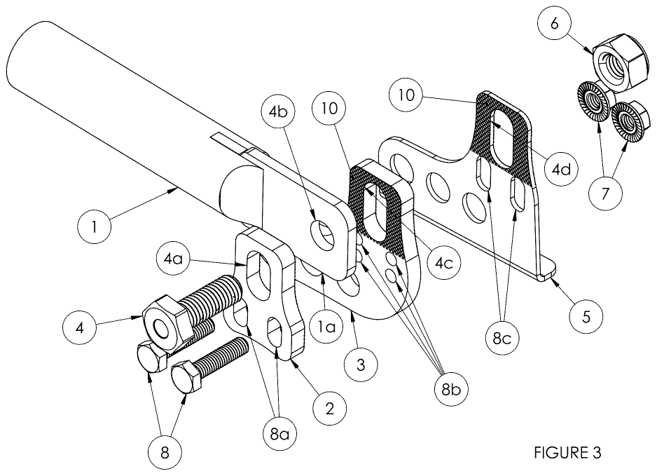

In configurations utilizing the reinforcement plate (5), the secondary fasteners (8) extend outward from the threaded bores (8b) and through corresponding elongated clearance apertures (8c) in the reinforcement plate (5) before being secured by locking nuts (7). This creates a multi-layered structural sandwich. In configurations where the reinforcement plate (5) is omitted, the locking nuts (7) are installed directly against the adjuster body (3). As shown in FIG. 3, the number of threaded bores (8b) preferably exceeds the number of clearance apertures (8a, 8c) to provide a range of selectable mounting positions.

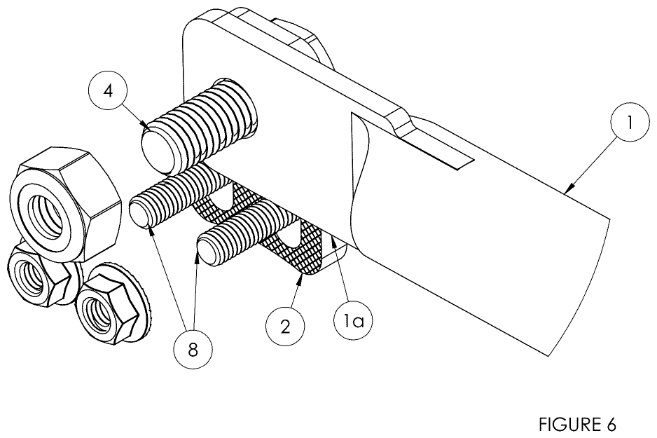

Referring to the detail view in FIG. 6, the mechanical stop geometry is disclosed. In a preferred installation, the secondary fasteners (8) are positioned substantially tangential to the perimeter margin (1a) (the outer edge) of the sway bar (1). This orientation allows the shank of the fasteners (8) to act as a physical mechanical stop. This creates a physical interference fit—a mechanical “dead-stop”—that prevents the assembly from rotating (clocking) even if the primary friction joint is momentarily overcome. For bars with rounded or non-linear edges, the fasteners (8) are selectively positioned within the apertures (8a, 8c) to intercept the arc of the perimeter margin (1a).

### Friction-Enhancing Features and Reinforcement

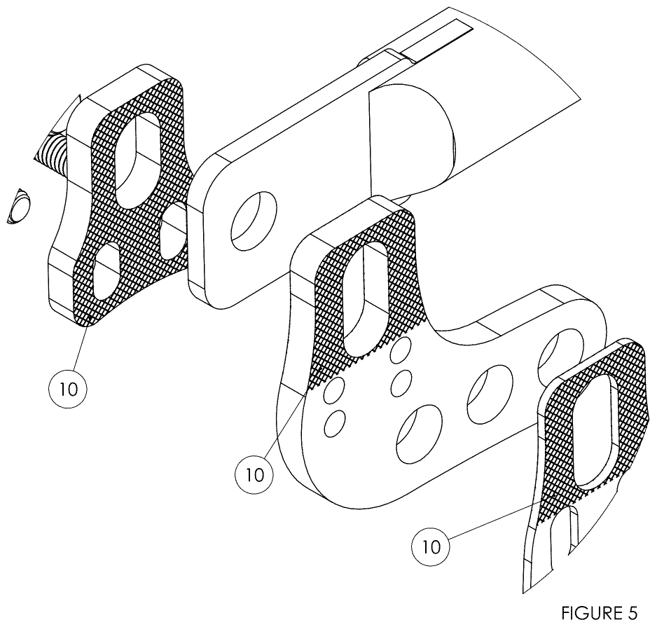

To further increase rotational resistance, as shown in FIG. 5, at least one mating surface includes integrally formed surface texturing (10). These features are configured to provide an affirmative mechanical engagement by minimally biting into the surface of the sway bar (1), providing redundant resistance supplemental to the mechanical stop provided by the secondary fasteners (8).

For applications subject to extreme side-loading or bending moments, the reinforcement plate (5) is included to redistribute loads. The reinforcement plate (5) includes a plurality of apertures (12d, 12e, 12f) configured to be concentric with the mounting apertures (12a, 12b, 12c) of the adjuster body. When an end-link is installed, the end-link fastener bridges both the adjuster body (3) and the reinforcement plate (5), creating a structural load-path that utilizes the inherent elasticity of the spring-steel sway bar (1).

The reinforcement plate (5) is effectively integrated into a singular structural unit with the adjuster body (3) via a multi-point connection. This includes the primary fastener (4) passing through aperture (4d), the secondary fasteners (8) passing through apertures (8c), and the end-link fastener passing through apertures (12d-f). By securing the plate across these multiple distinct coordinates, the assembly directs dynamic bending loads away from the rigid adjuster body (3) and into the sway bar (1). This synergistic relationship prevents localized fatigue of the rigid assembly components while allowing the sway bar to flex and return to its original geometry.

### LIST OF REFERENCE NUMERALS

1—Sway Bar
1a—Perimeter Margin (of Sway Bar)
2—Backing Plate
3—Adjuster Body
4—Primary Fastener
4a—Backing Plate Aperture (Primary)
4b—Sway Bar Aperture
4c—Adjuster Body Aperture (Primary)
4d—Reinforcement Plate Aperture (Primary)
5—Reinforcement Plate
6—Primary Nut
7—Locking Nuts (Secondary)
8—Secondary Fasteners
8a—Clearance Apertures (Backing Plate-Secondary)
8b—Threaded Bores (Adjuster Body-Secondary)
8c—Clearance Apertures (Reinforcement Plate-Secondary)
10—Surface Texturing
12a, 12b, 12c—Mounting Apertures (Adjuster Body)
12d, 12e, 12f—Mounting Apertures (Reinforcement Plate)

1. A sway bar adjuster assembly for an automotive suspension system, comprising:
(a) an adjuster body (3) configured to mount to a terminal end of a sway bar (1) and including a plurality of mounting apertures (12a-c);
(b) a backing plate (2) positioned on an opposite side of the sway bar relative to the adjuster body;
(c) a primary fastener (4) configured to pass through the backing plate, the adjuster body, and a pre-existing aperture (4b) in the sway bar;
(d) at least one secondary fastener (8) threadably engaged with the adjuster body (3);
wherein said secondary fastener (8) is positioned substantially tangential to a perimeter margin (1a) of the sway bar to provide a mechanical interference stop against rotational displacement.

2. The assembly of claim 1, wherein the backing plate (2) comprises at least one elongated clearance aperture (8a) configured to allow the secondary fastener (8) to intercept the perimeter margin (1a) across various sway bar edge profiles.

3. The assembly of claim 1, further comprising a reinforcement plate (5) disposed adjacent to the adjuster body (3) and integrated via a multi-point load path comprising the primary fastener (4), the secondary fastener (8), and an end-link fastener.

4. The assembly of claim 1, wherein at least one mounting surface includes integrally formed surface texturing (10) configured to affirmative mechanical engagement with a surface of the sway bar.

5. The assembly of claim 4, wherein the surface texturing (10) comprises a cross-hatched pattern.

6. The assembly of claim 1, wherein selecting a mounting aperture closer to the torsional axis of the sway bar increases roll stiffness by reducing an effective lever-arm length.

7. The assembly of claim 1, wherein the assembly is a retrofit kit configured for non-destructive engagement with the sway bar (1).

8. The assembly of claim 3, wherein the at least one secondary fastener (8) is threadably engaged with the adjuster body (3) and extends through the elongated clearance aperture (8c) of the reinforcement plate (5) to be secured by a locking nut (7), thereby defining a secondary compressive load path.
